(19) United States
(12) Patent Application Publication
(10) Pub. No.: US 2025/0135330 A1
(43) Pub. Date: May 1, 2025

(54) DROP RESISTANT CONTROLLER

(71) Applicant: Valve Corporation, Bellevue, WA (US)

(72) Inventors: Walter Petersen, Seattle, WA (US); Michael Baseflug, Duvall, WA (US)

(21) Appl. No.: 18/926,783

(22) Filed: Oct. 25, 2024

Related U.S. Application Data
(60) Provisional application No. 63/593,774, filed on Oct. 27, 2023.

(51) Int. Cl. A63F 13/24

(52) U.S. Cl. CPC A63F 13/24; A63F 2250/38

(57) ABSTRACT

A drop resistant controller is described. A control of the controller may include a cover, a circuit board disposed behind the cover and within a housing of the controller, and a switch mounted to the circuit board. The circuit board includes a cantilever portion, a main body portion, and a cutout defined in the circuit board between the cantilever portion and the main body portion. The switch is mounted to the circuit board on the cantilever portion and is configured to provide, to a processor(s), data indicative of an actuation of the control. Damage to the control, and/or to particular components thereof (e.g., the switch), is mitigated by the ability of the cantilever portion of the circuit board to flex under high-force impacts on the control.

### CROSS-REFERENCE TO RELATED APPLICATION

This application claims priority to and benefit of U.S. Provisional Application No. 63/593,774, filed Oct. 27, 2023, entitled “DROP RESISTANT CONTROLLER,” the entirety of which is incorporated by reference herein for all purposes.

### BACKGROUND

Handheld controllers are used in an array of architectures for providing input, for example, to a local or remote computing device. For instance, handheld controllers are utilized in the gaming industry to allow players to interact with a gaming application executing on a computing device, such as a game console, a game server, the handheld controller itself, or the like. Handheld controllers typically have one or more controls that are configured to be operated by one or more fingers of a user of the controller. These controls, and the electronic components (e.g., switches) associated therewith, are susceptible to damage when the controller is dropped on a hard surface, such as the ground. When a user is standing and holding the controller, the controller can be dropped from a height of about 1 meter (m) or more, causing a significant impact on the controller. Furthermore, the force of the impact is greater for heavier controllers. It can be challenging to design a controller with controls that have both the characteristics desired by end users and the ability to withstand impacts.

The disclosure made herein is presented with respect to these and other considerations.

### BRIEF DESCRIPTION OF THE DRAWINGS

The detailed description is described with reference to the accompanying figures. In the figures, the left-most digit(s) of a reference number identifies the figure in which the reference number first appears. The same, or like, reference numbers in different figures indicate similar or identical items.

FIG. 1A illustrates a perspective view of an example controller, FIG. 1A showing a back surface and a top surface of the controller housing, as well as example controls that reside on those surfaces.

FIG. 1B illustrates a zoomed-in view of a portion of the example controller of FIG. 1A, but with a back panel of the controller housing removed to show interior components of an example control disposed on the top surface of the controller housing.

FIG. 1C illustrates a zoomed-in view of another portion of the example controller of FIG. 1A, but with the back panel of the controller housing removed to show interior components of another example control disposed on the top surface of the controller housing.

FIG. 1D illustrates a further zoomed-in view of the portion of the example controller shown in FIG. 1C to show a close-up view of a cutout defined in an example circuit board of the control.

FIG. 2 illustrates some of the components in an assembly of components that make up the control shown in FIG. 1C, FIG. 2 showing, among other things, a switch mounted to a circuit board.

FIG. 3 illustrates example traces that may be part of an example circuit board of an example control.

FIG. 4 illustrates an example cover of an example control, the cover having a projection that extends from a back side of the cover towards a switch of the control, as well as an example cap disposed on the projection to reduce actuation sound and/or further mitigate damage to the control, and/or components thereof, in the event that the controller is dropped.

FIG. 5 illustrates prototype parts of an example cover of an example control, the cover having a projection that extends from a back side of the cover towards a switch of the control, as well as example caps disposed on the projection to reduce actuation sound and/or further mitigate damage to the control, and/or components thereof, in the event that the controller is dropped.

FIG. 6 illustrates a front view of an example controller with example controls for operation by fingers of a user of the controller.

FIG. 7 illustrates example functional components of an example controller system.

### DETAILED DESCRIPTION

As mentioned above, handheld controllers are used in a range of environments and include a range of functionality. However, particular components of traditional handheld controllers are prone to damage when the controllers are dropped on a hard surface, such as the ground. To date, rugged handheld controllers that have been designed to withstand impacts from dropping the controllers are unable to provide certain characteristics that end users desire, such as a crisp, tactile click when a control is actuated.

Described herein are, among other things, a drop resistant controller, and associated systems and methods. The controller (sometimes referred to herein as a “handheld controller”) may include one or more controls that are controllable by one or more fingers of a user of the controller. As disclosed herein, an assembly of components that make up a control of the controller provides the control with the ability to withstand impacts of significant forces, such those caused by dropping the controller on a hard surface, such as the ground. For example, a control of the controller may include a cover, a circuit board disposed behind the cover and within a housing of the controller, and a switch mounted to the circuit board. The cover is configured to move in response to a press on the cover by a finger of a user of the controller, which allows the user to actuate (e.g., depress) the control. The circuit board includes a cantilever portion, a main body portion, and a cutout defined in the circuit board between the cantilever portion and the main body portion. Furthermore, the switch is mounted to the circuit board on the cantilever portion and is configured to provide, to a processor(s) of a controller system that includes the controller, data indicative of an actuation of the control based at least in part on the cover moving into engagement with the switch as a result of the press on the cover by the finger. When the control is actuated by the finger of the user during normal operation of the controller, the cantilever portion of the circuit board does not flex because a stiffness of the cantilever portion is sufficient to inhibit flexion of the cantilever portion under the force of a typical press on the cover of the control. However, when a force applied to the cover of the control satisfies a threshold amount of force—which can occur when the controller is dropped from a height of at least 1 m and the impact from the ground occurs directly on the control—the cantilever portion is configured to flex, thereby absorbing at least some of energy from the impact. Accordingly, damage to the control, and/or to particular components thereof (e.g., the switch), is mitigated or otherwise reduced by the ability of the cantilever portion of the circuit board to flex under high-force impacts on the control.

The techniques, devices, and systems described herein provide a drop resistant controller without making any tradeoffs in terms of the “feel” of the control. Manufacturers of conventional handheld controllers have attempted to make their controllers more rugged and resistant to damage by, among other things, using rubber dome-type switches for the controls of the controller. The rubber dome-type switches are robust and resistant to high-impact loads from a drop, but they do not allow for maintaining a “feel” of the control that is desired by many end users; namely, a crisp, tactile click when the control is actuated. By contrast, the assembly of components that make up the control disclosed herein allows for maintaining a crisp, tactile click when the control is actuated, which is a desired by many end users. For example, the controller disclosed herein may be used to engage in video game play via an executing video game application, and/or to control other types of applications and/or programs, and the user of the controller may prefer a feel of a sharp “click” as a form of tactile feedback when operating the control with their finger.

In some examples, the handheld controller described herein can be heavier and thinner than the average handheld controller, which can make it particularly challenging to prevent damage to the controls, and/or the components thereof, in the event that the controller is dropped. For instance, a conventional handheld controller that is used for controlling a game console typically weighs between 150 to 300 grams, with a thickness in the range of about 40 to 60 millimeters (mm), which is relatively thick with respect to the overall size of such a controller. Because these conventional controllers are relatively lightweight and thick, it is less challenging to make them drop resistant. In some examples, the handheld controller disclosed herein can weigh between 600 to 800 grams, with a relatively thin profile considering the overall size of the controller (e.g., the controller may have dimensions of about 298 mm×117 mm×49 mm). In an example, the handheld controller disclosed herein may include a centrally-located display on the front surface of the controller housing, with front-surface controls to the left and to the right of the display, as well as top-surface controls, back surface controls, speakers, and/or a variety of electronic components within the housing. This example handheld controller may be used as a handheld gaming system that is substantially self-contained on the controller. In this example, the controller may be used to control a game or application running on the handheld controller itself. Accordingly, the disclosed drop resistant feature of the controller is particularly useful for handheld controllers that are relatively heavy, as the impact forces resulting from dropping the controller can be significantly greater than conventional controllers.

In some examples, the control that is drop resistant is a top-surface control that is disposed on a top surface of a housing of the controller. In some examples, the top-surface control may be controllable by an index finger of the user's hand when the user is holding the controller with a conventional grip. In some examples, the controller includes one or more left top-surface controls operable by one or more fingers (e.g., a left index finger) of a left hand of the user, and one or more right top-surface controls operable by one or more fingers (e.g., a right index finger) of a right hand of the user. In some examples, the one or more top-surface controls include one or more bumpers, such as a left bumper and a right bumper. With conventional handheld controllers, the components (e.g., switches) of the bumpers can be damaged and rendered non-functional after a single drop of the controller from a height of less than 1 m. By contrast, the disclosed assembly of components that, in some examples, make up the bumper disposed on the top surface of the controller housing provide a bumper that is able to withstand multiple drops at and above 1 m, which has been verified through rigorous drop and impact testing. Accordingly, the drop resistant feature disclosed herein is particularly useful for the bumpers of handheld controllers that include bumpers on the top surface of the controller housing.

The techniques, devices, and systems described herein provide a low cost impact absorption mechanism without any extra components. For instance, manufacturers of conventional handheld controllers have attempted to make their controllers more rugged and resistant to damage by adding breakaway mechanisms that allow the switch of the control to break away from the cover (or button) when the cover is impacted with an above-threshold amount of force that is higher than the typical force of a press from a user of the controller. However, such breakaway mechanisms add cost and complexity due to the extra components and/or parts that are used to provide a control that is more robust and drop resistant. By contrast, the disclosed assembly of components that make up the control of the controller provide an impact absorption mechanism without any extra parts by virtue of a cutout defined in the circuit board on which the switch of the control is mounted. Specifically, the switch of the control is mounted on the cantilever portion of the circuit board, and because the cantilever portion is configured to flex under a force applied to the cover that satisfies a threshold amount of force, at least some of the energy associated with the impact can be absorbed by the flexure of the cantilever portion to provide a low cost impact absorption mechanism that is less complex than other known breakaway mechanisms.

In some examples, the circuit board of the control disclosed herein is easy and relatively cheap to replace, if necessary. If, for instance, an owner of the controller disclosed herein, uses the controller for a long time, the functionality of the control may degrade under normal wear and tear. Accordingly, in some examples, the circuit board on which the switch of the control is mounted is separate from a main printed circuit board assembly (PCBA) of the controller. For example, the circuit board may be a sub-assembly printed circuit board (PCB), such as a sub-assembly PCB of a joystick of the controller, which may be disposed on a front surface of the housing of the controller, and/or a sub-assembly PCB of a bumper of the controller. Because this circuit board can be replaced without having to replace the main PCBA, the disclosed control assembly provides a low cost option for servicing the control (e.g., a bumper) and/or the joystick because the main PCBA—which may be used as the substrate for several expensive chips and other electronic components—can remain intact within the housing of the controller while replacing the circuit board of the drop resistant control.

Additional techniques, devices, and systems for mitigating damage to the control, and/or components thereof, are disclosed herein, such as the cantilever portion and the main body portion of the circuit board being coplanar and the cutout having an optimal width to limit the range of motion of the cantilever portion, thereby reducing the likelihood of a crack developing in the circuit board at the proximal end of the cantilever portion. Other techniques include providing traces associated with the switch of the control having sufficiently wide trace widths to reduce the likelihood of the traces fracturing and being rendered inoperable for carrying electrical signals, providing one or more backup traces for the switch to provide redundancy in the event that the primary trace(s), and providing a cutout with a terminating end that is wider than the remainder of the cutout for stress reduction.

The present disclosure provides an overall understanding of the principles of the structure, function, manufacture, and use of the systems and methods disclosed herein. One or more examples of the present disclosure are illustrated in the accompanying drawings. Those of ordinary skill in the art will understand that the systems and methods specifically described herein and illustrated in the accompanying drawings are non-limiting embodiments. The features illustrated or described in connection with one embodiment may be combined with the features of other embodiments, including as between systems and methods. Such modifications and variations are intended to be included within the scope of the appended claims.

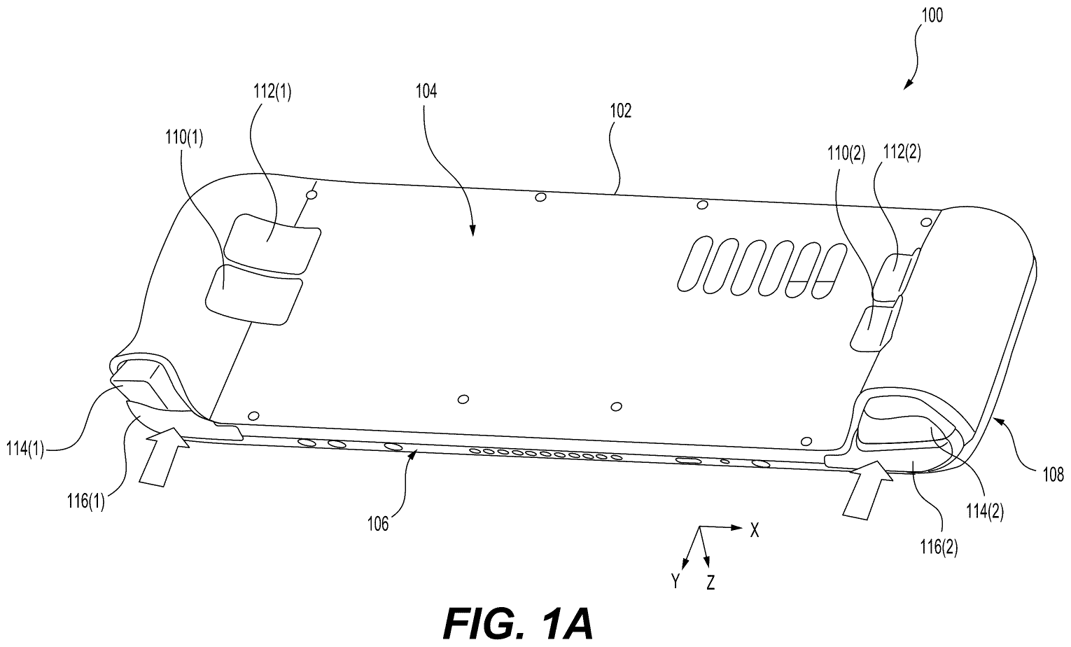

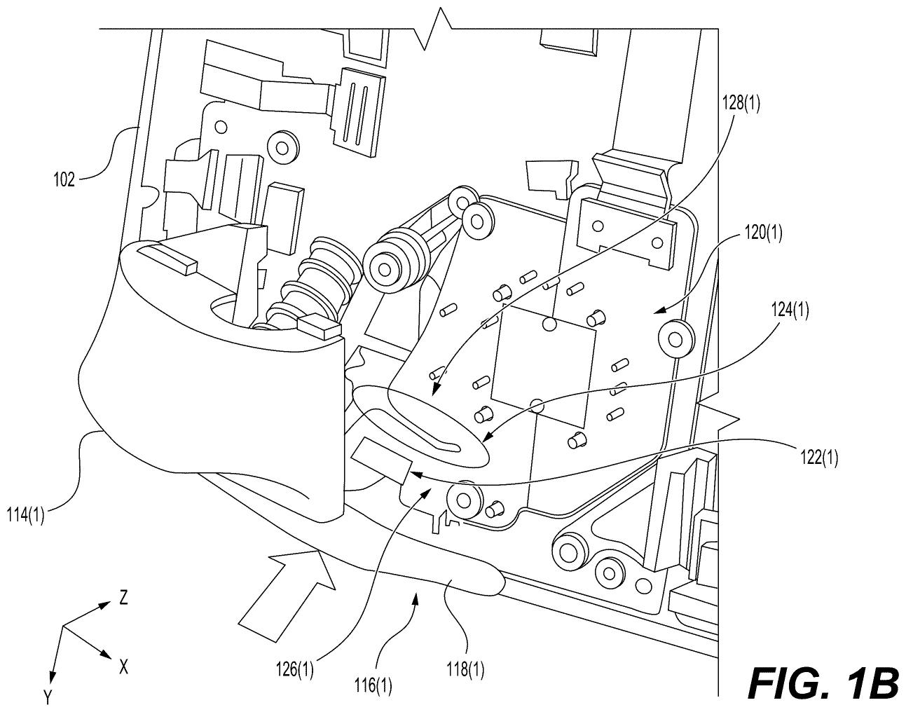

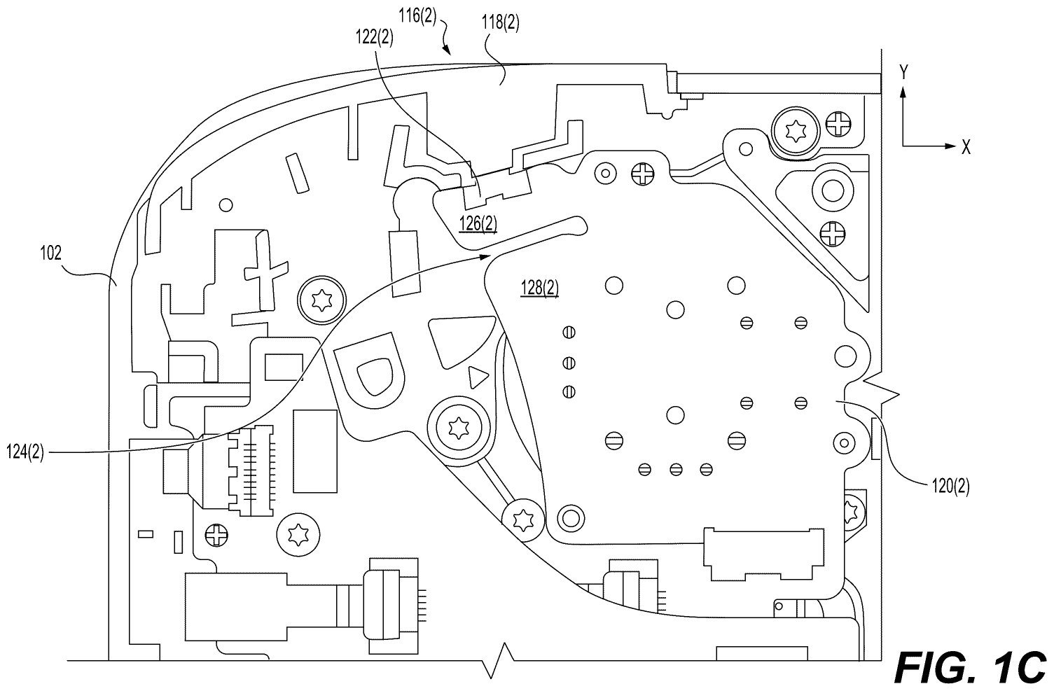

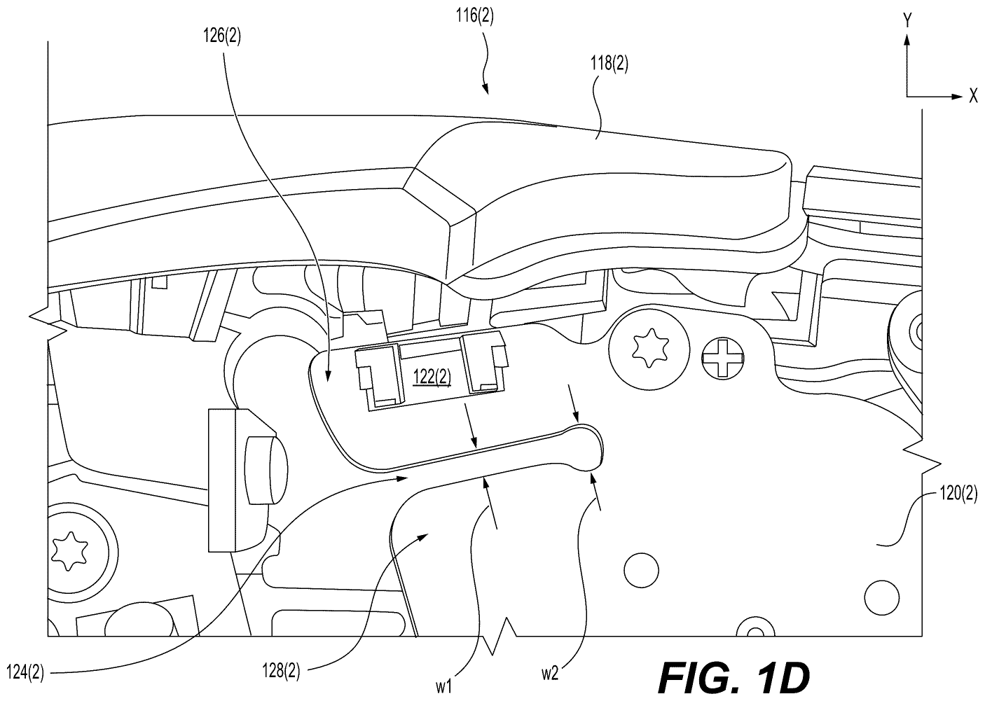

FIG. 1A illustrates a perspective view of an example controller 100. In accordance with various embodiments described herein, the terms “device,” “handheld device,” “handheld game device,” “handheld console,” “handheld game console,” “controller,” and “handheld controller” may be used interchangeably herein to describe any device like the controller 100. The controller 100 may be considered to be “handheld” if the controller 100 is operated by one or more hands of a user, whether or not the entire controller 100 is supported by, or held within, the hand(s) of the user.

The controller 100 may include a housing 102. The housing 102 of the controller 100 may have various surfaces including a front surface (or front), a back surface 104 (or back), a top surface 106 (or top edge, or top), a bottom surface (or bottom edge, or bottom), a left surface (or left edge, or left), and a right surface 108 (or right edge, or right). With the perspective view of FIG. 1A, the front surface, the bottom surface, and the left surface are hidden from view in FIG. 1A, but the back surface 104, the top surface 106, and the right surface 108 are visible in FIG. 1A. An example housing 102 with these six surfaces may be a cuboid. Furthermore, the front surface (not shown in FIG. 1A) and the back surface 104 may be relatively large surfaces compared to the top, bottom, left, and right surfaces of the housing 102.

As illustrated in FIG. 1A, the back surface 104 of the housing 102 may include a plurality of controls 110(1), 110(2), 112(1), and 112(2) that are configured to receive input of the user. These controls 110, 112 may be referred to herein as “back-surface controls” or “grip buttons.” In some examples, when a user of the controller 100 is holding the controller 100 with a conventional grip, a first back-surface control 110(1) is controllable by a left ring finger of a left hand of the user, a second back-surface control 110(2) is controllable by a right ring finger of a right hand of the user, a third back-surface control 112(1) is controllable by a left pinky finger of the left hand, and a fourth back-surface control 112(2) is controllable by a right pinky finger of the right hand.

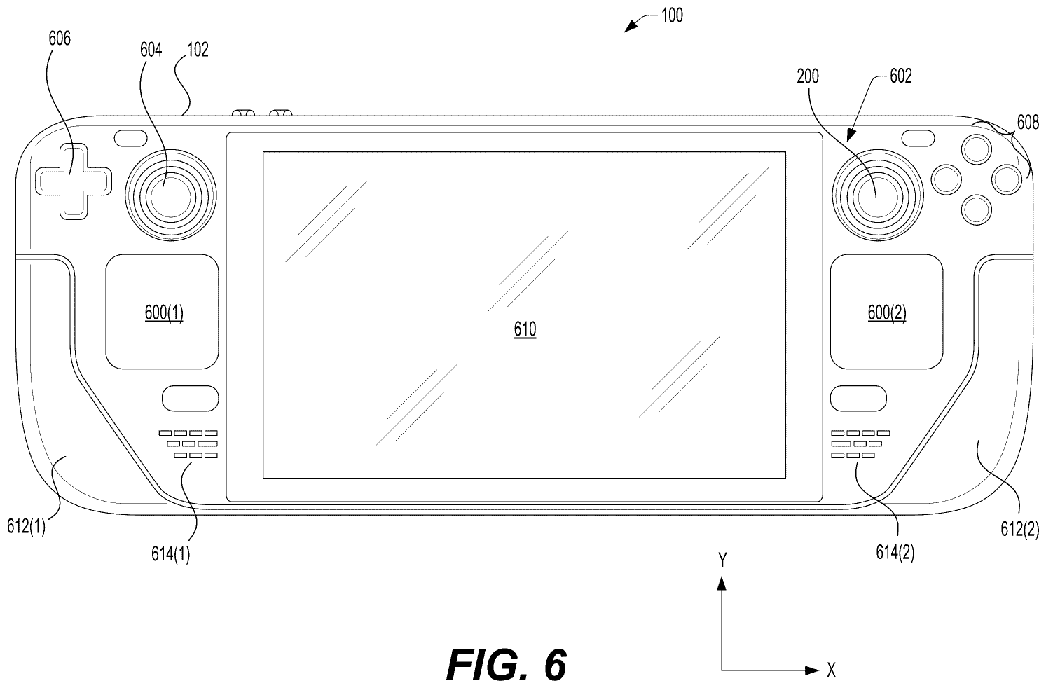

The top surface 106 of the housing 102 may include a plurality of controls 114(1), 114(2), 116(1), 116(2). These controls 114, 116 may be referred to herein as “top-surface controls.” In some examples, when the user is holding the controller 100 with the conventional grip, a first top-surface control 114(1) is controllable by a left middle finger of the left hand, a second top-surface control 114(2) is controllable by a right middle finger of the right hand, a third top-surface control 116(1) is controllable by a left index finger of the left hand, and a fourth top-surface control 116(2) is controllable by a right index finger of the right hand. The first top-surface control 114(1) is sometimes referred to herein as a “left trigger,” the second top-surface control 114(2) is sometimes referred to herein as a “right trigger.” the third top-surface control 116(1) is sometimes referred to herein as a “left bumper,” and the fourth top-surface control 116(2) is sometimes referred to herein as a “right bumper.” The handheld controller 100 may further include one or more front-surface controls residing on a front surface of the housing 102. These front-surface controls are described in more detail below with reference to FIG. 6. Additionally, or alternatively, the handheld controller 100 may include one or more bottom-surface controls residing on the bottom surface of the housing 102. Additionally, or alternatively, the handheld controller 100 may include one or more left-surface controls and/or right-surface controls residing on respective left and right surfaces of the housing 102.

FIG. 1A further illustrates that, when the controller 100 is dropped and collides with a hard surface, such as the ground, the controller 100 may impact the hard surface (e.g., the ground) on the control 116(1) and/or the control 116(2). This is shown in FIG. 1A by the arrows directed towards the controls 116(1) and 116(2) and labeled with “Impact.” FIG. 1B illustrates a zoomed-in view of a portion of the example controller 100 of FIG. 1A, but with a back panel of the controller housing 102 removed to show interior components of the control 116(1) (e.g., the left bumper). These interior components of the control 116(1) provide the control 116(1) with the ability to withstand impacts of significant forces, such those caused by dropping the controller 100 on a hard surface, such as the ground, from a height of at least about 1 m. Although FIG. 1B illustrates an assembly of components that make up the control 116(1) (e.g., the left bumper), it is to be appreciated that other controls of the controller 100 may include the same or similar components to provide drop resistance for any of the controls of the controller 100. For example, the control 116(2) may include the same or similar components to provide drop resistance, which is described in more detail below with reference to later figures.

As shown in FIG. 1B, the control 116(1) includes a cover 118(1). The cover 118(1), as its name implies, may cover the components of the control 116(1) that are disposed behind the cover 118(1). Accordingly, because the cover 118(1) is an externally-facing component of the control 116(1), the remaining components of the control 116(1) may be concealed by the cover 118(1), at least when the control 116(1) is implemented in the controller 100. In some examples, the cover 118(1) may be configured to be disposed within an opening defined in the housing 102 of a controller 100. The housing 102 may house the internal components of the controller 100, including the components of the control 116(1) that are disposed behind the cover 118(1). For instance, the cover 118(1) may represent the visible part of the control 116(1) while the internal components of the control 116(1) are not visible when the controller 100 is fully assembled (e.g., as shown in FIG. 1A). In general, the cover 118(1) is configured to be interacted with (e.g., pressed upon, hovered over, touched, etc.) in order to operate the control 116(1). For example, a user may operate the control 116(1) by pressing on the cover 118(1) (e.g., exerting a force on the cover 118(1) in the negative Y direction). In some examples, the cover 118(1) may move (e.g., in the negative Y direction) in response to the press on the cover 118(1) (e.g., from the cover 118(1) may move from an initial position to a depressed position that closer to the internal components within the housing 102). In some examples, the cover 118(1) is biased by a biasing member(s) (e.g., a spring(s)) in an outward direction away from the housing 102 (e.g., the positive Y direction), and the press on the cover 118(1) in the negative Y direction may cause the cover 118(1) to move inward towards the internal components within the housing 102, as long as the force of the press is greater than the biasing force on the cover 118(1). In some examples, the user may touch the cover 118(1) with a finger (e.g., an index finger) and/or drag the finger across the cover 118(1) to control an aspect of an executing application (e.g., to toggle through options in an executing video game). Because the examples herein contemplate the control 116(1) being implemented on the top surface 106 of the controller 100, the Y direction shown in the figures is meant to represent a positive Y direction that is orthogonal to a leftward or rightward direction (e.g., X direction). Furthermore, components that are disposed in the negative Y direction relative to the cover 118(1) are referred to herein as being “behind” the cover 118(1), although it is to be appreciated that, these components may be referred to as being “underneath” the cover 118(1), or even “in front of” the cover 118(1) in some instances, such as when the internal components are associated with a back-surface control (e.g., any of the controls 110, 112).

The control 116(1) may further include a circuit board 120(1) (sometimes referred to herein as a “PCB” or a “sub-assembly PCB”). The circuit board 120(1) may be disposed behind the cover 118(1) and within the housing 102. In the example of FIG. 1B, the circuit board 120(1) is mounted to the housing 102 via multiple fasteners (e.g., screws), and a plane of the circuit board 120(1) is substantially parallel to the back surface 104 and/or the front surface of the housing 102. Various components (e.g., electronic components) may be mounted to the circuit board 120(1) of the control 116(1). At least one of the components mounted to the circuit board 120(1) is a switch 122(1) of the control 116(1). As noted above, the cover 118(1) may move (e.g., in the negative Y direction) in response to a press on the cover 118(1) by a finger (e.g., an index finger) of a user of the controller 100. In this scenario, the cover 118(1) may move into engagement (or contact) with the switch 122(1) as a result of the press on the cover 118(1). In some examples, the cover 118(1) may include a projection (e.g., cross ribs, cruciform ribs, etc.) that extends from a back side of the cover 118(1) towards the switch 122(1). In these examples, the projection may be configured to engage the switch 122(1) when the cover 118(1) is moved into a depressed position. In turn, the switch 122(1) may provide, to a processor(s), data indicative of an actuation of the control 116(1) based at least in part on the cover 118(1) (e.g., the projection thereof) moving into engagement with the switch 122(1) as a result of the press on the cover 118(1) by the finger.

As shown in FIG. 1B, a cutout 124(1) is defined in the circuit board 120(1). In the example of FIG. 1B, a length of the cutout 124(1) extends substantially in the X direction. However, the cutout 124(1) can be angled slightly towards the Y direction. The cutout 124(1) (sometimes referred to herein as a “slot” or a “channel”) extends partway into the circuit board 120(1) such that the circuit board 120(1) is still a unitary piece of material notwithstanding the cutout 124(1). The cutout 124(1) partitions the circuit board 120(1) into two portions: a cantilever portion 126(1) and a main body portion 128(1). The switch 122(1) is mounted to the circuit board 120(1) on the cantilever portion 126(1), and the cantilever portion 126(1) is configured to flex in response to a force applied to the cover 118(1) that satisfies a threshold amount of force, such as a force caused by an impact on the control 116(1) and/or the cover 118(1) thereof. As used herein, a force can “satisfy” a threshold amount of force if the force is equal to or greater than (e.g., meets or exceeds) the threshold amount of force, or if the force is strictly greater than (e.g., strictly exceeds) the threshold amount of force. The circuit board 120(1) and/or the cantilever portion 126(1) may be made of a resilient material (e.g., laminate PCB material, such as glass reinforced epoxy resin) such that the cantilever portion 126(1) returns to its original position (e.g., as shown in FIG. 1B) like a spring board after flexure and after the force applied to the cover 118(1) ceases. The threshold amount of force to cause flexure of the cantilever portion 126(1) may be greater than a typical amount of force of a press on the cover 118(1) by a finger of a user of the controller 100. The threshold amount of force to cause flexure of the cantilever portion 126(1) may be less than a force of an impact when the controller 100 is dropped from a height of at least about 0.1 m, 0.2 m, 0.3 m, 0.4 m, 0.5 m, 0.6 m, 0.7 m, 0.8 m, 0.9 m, 1 m, or greater. An example equation to calculate the impact force, F, on the controller 100 with a mass, m, dropped from a height, h, is F=ma_{g}h/s, a_{g} is the acceleration of gravity, and s is the deformation slow-down distance. As such, the dimensions and/or the stiffness of the cantilever portion 126(1) can be designed based on the mass of the controller 100 such that a typical press on the cover 118(1) by a user is unlikely to cause flexure of the cantilever portion 126(1). That is, a stiffness of the cantilever portion 126(1) may be such that the cantilever portion 126(1) does not flex in response to a force of a press on the cover 118(1) failing to satisfy the threshold amount of force mentioned above.

The disclosed assembly of components that make up the example control 116(1) shown in FIG. 1B provides a low cost impact absorption mechanism without any extra components or parts by virtue of the cutout 124(1) defined in the circuit board 120(1) on which the switch 122(1) of the control 116(1) is mounted. Specifically, the switch 122(1) of the control 116(1) is mounted on the cantilever portion 126(1) of the circuit board 120(1), and because the cantilever portion 126(1) is configured to flex under a force applied to the cover 118(1) that satisfies a threshold amount of force, at least some of the energy associated with the impact can be absorbed by the flexure of the cantilever portion 126(1) to provide a low cost impact absorption mechanism that is less complex than other known breakaway mechanisms.

Accordingly, the example of FIG. 1B illustrates a portion of a controller 100 that is drop resistant by mitigating or otherwise reducing damage to the control 116, and/or components thereof (e.g., the switch 122(1)), in the event that the controller 100 is dropped from a height of at least about 1 m.

Furthermore, the disclosed assembly of components that make up the example control 116(1) shown in FIG. 1B provides a drop resistant controller without making any tradeoffs in terms of the “feel” of the control 116(1). Specifically, the disclosed assembly of components that make up the example control 116(1) shown in FIG. 1B allows for maintaining a crisp, tactile click when the control 116(1) is actuated, which is a desired by many end users. This is due, at least in part, to maintaining a preferred “click ratio” (or “tactile ratio”) of about 50% by virtue of avoiding the addition of a multitude of components and parts between the cover 118(1) and the switch 122(1). Here, the “click ratio” is defined as a ratio of the force it takes to initiate movement of the cover 118(1) of the control 116(1) to the force it takes to move the cover 118(1) all the way to a fully depressed position (e.g., where the control 116(1) “bottoms out”).

FIG. 1C illustrates a zoomed-in view of another portion of the example controller 100 of FIG. 1A, but with the back panel of the controller housing 102 removed to show interior components of another example control 116(2) (e.g., the right bumper) disposed on the top surface 106 of the controller housing 102. As shown in FIG. 1C, the control 116(2) includes a cover 118(2), which may be the same as, or similar to, the cover 118(1) of the control 116(1) described above, except that the orientation may be reversed since the control 116(2) is disposed on the right side of the controller 100 and the control 116(1) is disposed on the left side of the controller 100. The control 116(2) may further include a circuit board 120(2), which may be the same as, or similar to, the circuit board 120(1) of the control 116(1) described above, except that the orientation may be reversed for the reason noted above. In the example of FIG. 1C, a switch 122(2) is mounted to the circuit board 120(2), which may be the same as, or similar to, the switch 122(1) of the control 116(1) described above.

As shown in FIG. 1C, a cutout 124(2) is defined in the circuit board 120(2), and a length of the cutout 124(2) extends substantially in the X direction. However, as described above, the cutout 124(2) can be angled slightly towards the Y direction. FIG. 1C illustrates the angle of the cutout 124(2) relative to X direction, which may be an angle within the range of 1 to 45 degrees relative to the X direction. The cutout 124(2) extends partway into the circuit board 120(2) such that the circuit board 120(2) is still a unitary piece of material notwithstanding the cutout 124(2). The cutout 124(2) partitions the circuit board 120(2) into two portions: a cantilever portion 126(2) and a main body portion 128(2). The switch 122(2) is mounted to the circuit board 120(2) on the cantilever portion 126(2), which is configured to flex in response to a force applied to the cover 118(2) that satisfies a threshold amount of force, such as a force caused by an impact on the control 116(2) and/or the cover 118(2) thereof. The cantilever portion 126(2) is configured to return to its original position (e.g., as shown in FIG. 1C) after flexure and after the force applied to the cover 118(2) ceases, as described above with reference to the control 116(1) of FIG. 1B.

Accordingly, the disclosed assembly of components that make up the example control 116(2) shown in FIG. 1C provides a low cost impact absorption mechanism for drop resistance without making any tradeoffs in terms of the “feel” of the control 116(2), as described above with reference to the control 116(1) of FIG. 1B. In the examples described herein, the controller 100 can be made to be drop resistant such that damage to both the control 116(1) (e.g., the left bumper) and the control 116(2) (e.g., the right bumper) is mitigated or otherwise reduced in the event that the controller 100 is dropped by an end user.

FIG. 1D illustrates a further zoomed-in view of the portion of the example controller 100 shown in FIG. 1C to show a close-up view of the cutout 124(2) defined in the circuit board 120(2) of the control 116(2). As shown in FIG. 1D, the cutout 124(2) is elongate, substantially straight, and extends from a periphery of the circuit board 120(2) to a point on the circuit board 120(2) where the cutout 124(2) terminates. As further shown in FIG. 1D, the cutout 124(2) may have a first width, w1, along a length of the cutout 124(2), and a terminating end of the cutout 124(2) may have a second width, w2, greater than the first width, w1. In the example of FIG. 1D, the terminating end of the cutout 124(2) has a bulb shape for stress reduction. This wider, bulb-shaped end of the cutout 124(2) reduces the likelihood of stress concentrations in the event of an impact from dropping the controller 100, where the impact occurs on the control 116(2). This allows the cantilever portion 126(2) to flex and/or bend while reducing the chance of the cantilever portion 126(2) breaking near the terminating end of the cutout 124(2). The first width, w1, of the cutout 124(2) may vary depending on the implementation. Nevertheless, an optimal first width, w1, may be wide enough to allow for flexion of the cantilever portion 126(2) of the circuit board 120(2) for impact energy absorption, and thin enough to prevent the cantilever portion 126(2) from flexing to a point where the likelihood of breakage or fracture is high.

FIG. 1D shows an example where the cutout 124(2) is devoid of filler material. However, it is to be appreciated that inner edges of the cutout 124(2) may be lined, and/or the cutout 124(2) may be at least partially filled, with a compliant material (e.g., a rubber, silicone, Styrofoam, etc.) that compresses when the cantilever portion 126(2) flexes under a force of an impact to help absorb energy from an impact and mitigate damage to the control 116(2), and/or components thereof (e.g., the switch 122(2)) in the event that the controller 100 is dropped. Nevertheless, having the cutout 124(2) devoid of extra material may reduce the cost to manufacture the controller 100, and, therefore, it may be beneficial to leave the cutout 124(2) devoid of any extra material.

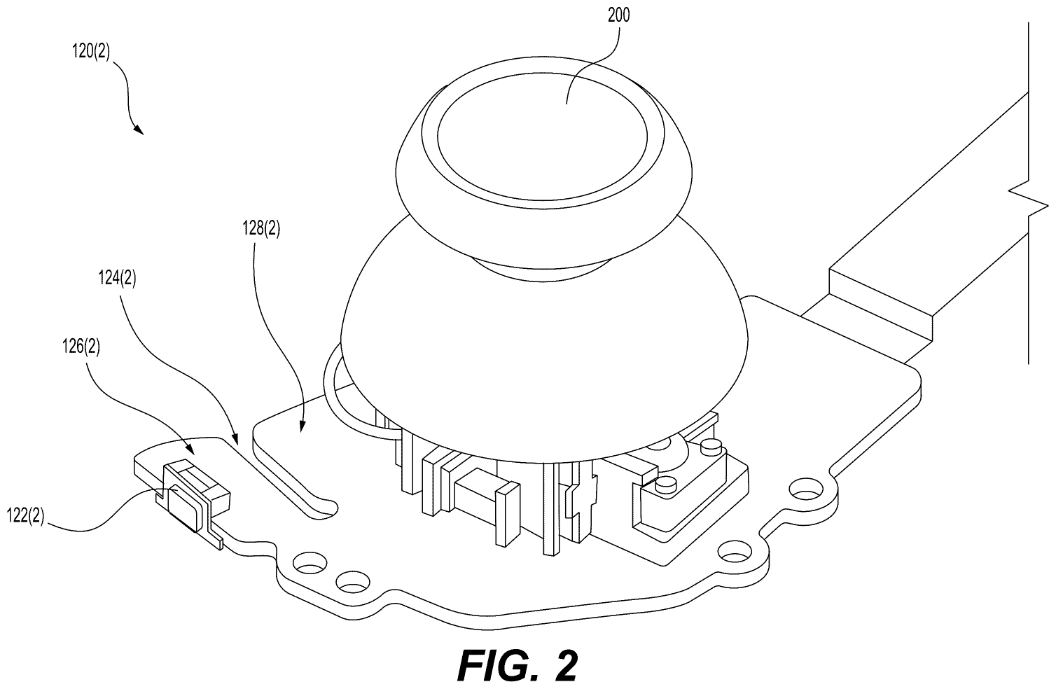

FIG. 2 illustrates some of the components in an assembly of components that make up the control 116(2) shown in FIG. 1C, FIG. 2 showing, among other things, the switch 122(2) mounted to the circuit board 120(2). As shown in FIG. 2, the cantilever portion 126(2) and the main body portion 128(2) of the circuit board 120(2) are coplanar. Accordingly, in some examples, the cantilever portion 126(2) may be configured to move from an initial position to a maximum deflected position where the cantilever portion 126(2) has moved into engagement with the main body portion 128(2). In other words, the range of motion of the cantilever portion 126(2) may be limited by the main body portion 128(2) of the circuit board 120(2), which may mitigate or otherwise reduce the likelihood of breakage or fracture of the cantilever portion 126(2) at a point near the terminating end of the cutout 124(2). Additionally, or alternatively, the housing 102 and/or the cover 118(2) of the control 116(2) may include stops (e.g., plastic hard stops) that are configured to prevent the cover 118(2) and/or the cantilever portion 126(2) of the circuit board 120(2) from moving beyond a certain distance prior to the cantilever portion 126(2) engaging the main body portion 128(2) of the circuit board 120(2).

FIG. 2 further illustrates that the circuit board 120(2) is configured to be replaced without having to replace a main PCBA of the controller 100 that is used as the substrate for several expensive chips and other electronic components of the controller 100. For example, the circuit board 120(2) shown in FIG. 2 may represent be a sub-assembly PCB of a joystick 200 of the controller 100. The joystick 200 may be disposed on a front surface of the housing 102 of the controller 100, as shown in FIG. 6. The circuit board 120(2) shown in FIG. 2 may additionally, or alternatively, represent be a sub-assembly PCB of the control 116(2) (e.g., the right bumper) of the controller 100. Because the circuit board 120(2) can be replaced without having to replace the main PCBA, a low cost option for servicing the control 116(2) (e.g., the right bumper) and/or the joystick 200 is provided by allowing the main PCBA to remain intact within the housing 102 of the controller 100 while replacing the circuit board 120(2). A user of the controller 100 may want to replace the circuit board 120(2) if, for instance, the user has owned the controller 100 for a long time and used the control 116(2) and/or the joystick 200 repeatedly to the point where the functionality of either control degrades under normal wear and tear.

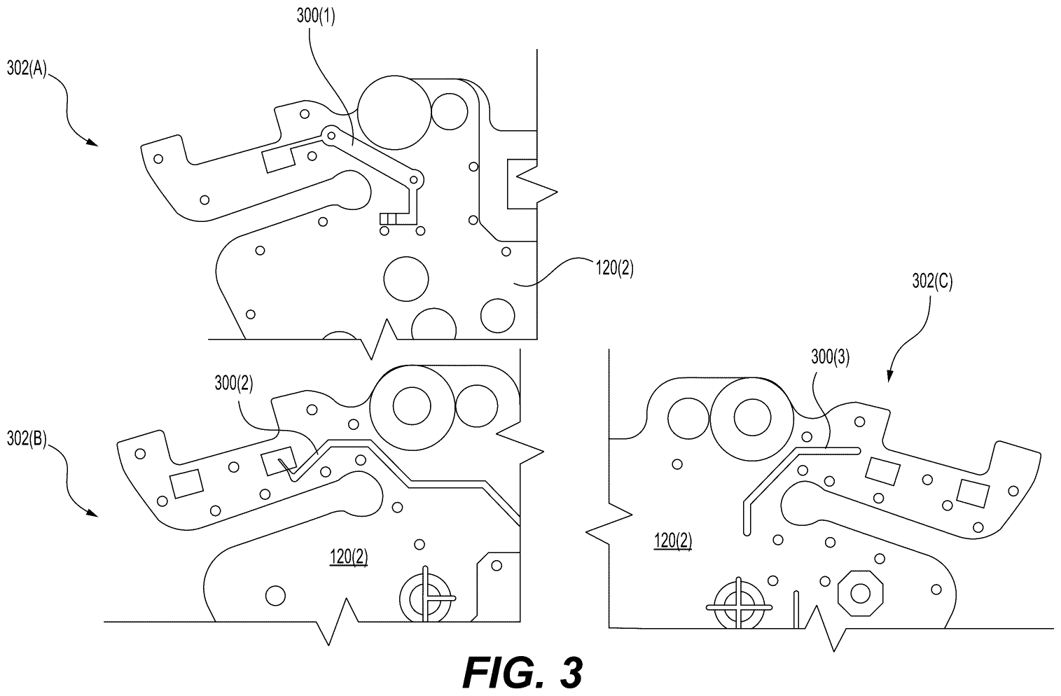

FIG. 3 illustrates example traces 300 that may be part of an example circuit board 120(2) of an example control 116(2). The circuit board 120(2) may include one or more traces 300 associated with the switch 122(2) of the control 116(2). The trace(s) 300 are configured to deliver electrical signals to a processor(s). These electrical signals may correspond to data indicative of an actuation of the control 116(2) based at least in part on the cover 118(2) of the control 116(2) moving into engagement with the switch 122(2) as a result of a press on the cover 118(2) by a finger (e.g., an index finger) of a user of the controller 100. FIG. 3 shows three example views 302 of a portion of the circuit board 120(2). A first view 302(A) depicts a first trace 300(1) associated with the switch 122(2) of the control 116(2), a second view 302(B) depicts a second trace 300(2) associated with the switch 122(2), and a third view 302(C) depicts a third trace 300(3) associated with the switch 122(2). The traces 300, in the example of FIG. 3, have been enlarged to be wider than a typical trace width to preserve functionality of the switch 122(2) in the event of cracks that develop in the circuit board 120(2) due to flexure of the cantilever portion 126(2). Typically, when designing traces for switches on a PCB, the objective is to design the traces to be as small as possible to fit within a small area of the PCB. Contrary to the conventional approach, the traces 300 associated with the switch 122(2) of the control 116(2) are wider than a typical trace width. For example, a width of an individual trace 300 may be at least about 30 mils. In some examples, a width of an individual trace 300 may be within a range of about 30 to 50 mils. With these wider trace widths, even if a crack develops in the circuit board 120(2) at the base of the cantilever portion 126(2) (e.g., a crack in the copper layer of the circuit board 120(2)), the switch 122(2) is likely to remain functional because the electrical connection provided by the wider trace 300 is more likely to remains intact, as compared to a thinner trace.

In some examples, at least one of the traces 300 shown in FIG. 3 serves as a backup trace(s) 300 to another primary trace(s) 300 associated with the switch 122(2). For example, the circuit board 120(2), in some examples, may include a plurality of traces 300, such as the traces 300(1)-(3), associated with the switch 122(2) of the control 116(2), and a first subset of the plurality of traces 300 represents one or more primary traces 300, and a second subset of the plurality of traces 300 represents one or more backup traces 300 configured to deliver the electrical signals in the event that the one or more primary traces 300 become damaged due to flexion of the cantilever portion 126(2) of the circuit board 120(2). For instance, the trace 300(3) may serve as a backup trace to a primary trace 300(1). Accordingly, multiple traces 300 associated with the switch 122(2) of the control 116(2) can provide redundancy in the event that the primary trace(s) 300 are damaged to the point of a loss of electrical connection. In some examples, the circuit board 120(2) includes multiple layers, which provide multiple pathways for traces 300 associated with the switch 122(2).

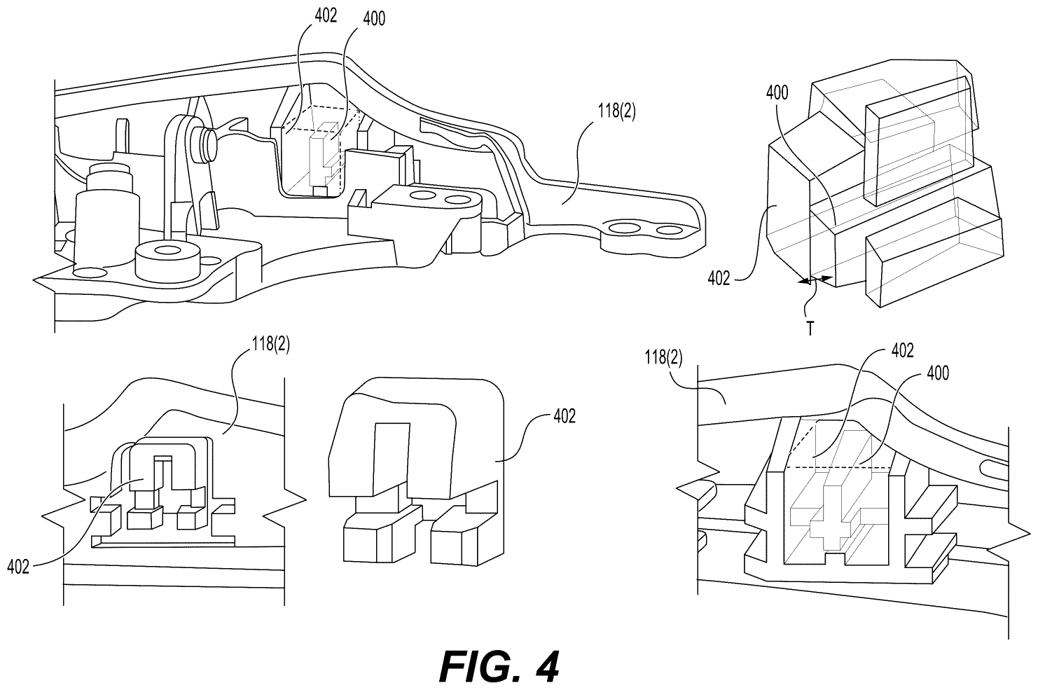

FIG. 4 illustrates the example cover 118(2) of the control 116(2), the cover 118(2) having a projection 400 that extends from a back side of the cover 118(2) towards the switch 122(2) (the switch 122(2) is not shown in FIG. 4) of the control 116(2). As noted above with respect to the cover 118(1) of the control 116(1), this projection 400 (e.g., cross ribs, cruciform ribs, etc.) may be configured to engage the switch 122(2) when the cover 118(2) is moved into a depressed position. In turn, the switch 122(2) may provide, to a processor(s), data indicative of an actuation of the control 116(2) based at least in part on the cover 118(2) (e.g., the projection 400 thereof) moving into engagement with the switch 122(2) as a result of the press on the cover 118(2) by a finger (e.g., an index finger). FIG. 4 also depicts an example cap 402 (or “sleeve”) disposed on the projection 400 to reduce actuation sound and/or further mitigate damage to the control 116(2), and/or components thereof (e.g., the switch 122(2)), in the event that the controller 100 is dropped. The cap 402 can be made of a compliant material (e.g., rubber, silicone, etc.) and may be configured to engage the switch 122(2) as a result of a press on the cover 118(2) by the finger. In some examples, a thickness, T, of an end of the cap 402 that is disposed on a distal end of the projection 400 is no greater than about 1 millimeter (mm). One benefit of including the cap 402 on the projection 400 is that the cap 402 reduces or dampens the sound resulting from actuation of the control 116(2), thus making it quieter to operate the control 116(2) during use of the controller 100. Nevertheless, the thickness, T, of the cap 402 at no greater than about 1 mm provides enough cushion to help absorb energy from an impact when the controller 100 is dropped without compromising the “feel” of the control 116(2) that is desired by end users; namely, a sharp, tactile click when the control 116(2) is actuated.

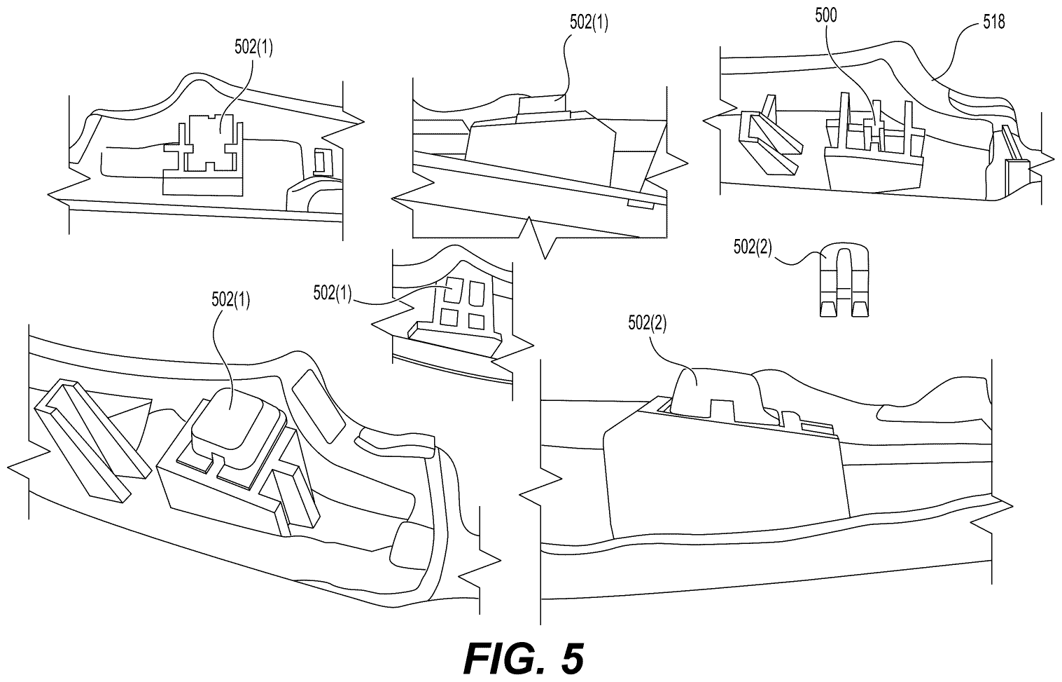

FIG. 5 illustrates prototype parts of an example cover 518 of an example control 116(2), the cover 518 having a projection 500 that extends from a back side of the cover 518 towards a switch (not shown in FIG. 5) of the control 116(2), as well as example caps 502(1) and 502(2) configured to be disposed on the projection 500 to reduce actuation sound and/or further mitigate damage to the control 116(2), and/or components thereof (e.g., the switch 122(2)), in the event that the controller 100 is dropped. The cover 518 may be similar to the covers 118 described above, and the prototype caps 502(1) and 502(2) may be similar to the example cap 402 described above with reference to FIG. 4.

Testing: A prototype controller similar to the drop resistant controller 100 described herein was tested over numerous drop and impact tests to verify its drop resistance as the ability to withstand multiple drops at and above 1 m without loss of functionality of the controls 116(1) and 116(2) described above. The testing was performed with a proprietary test machine that drops a point load that weighs the same as the controller 100 directly on the control 116(1) (e.g., the left bumper) and the control 116(2) (e.g., the right bumper) from a height of 1 m. The results of the testing confirmed that the switch 122 of the control 116 remains functional after five impacts, with only slight degradation in the “feel” of the control 116 when the control 116 is actuated. Because the proprietary test machine utilized to test the prototype controller exerts impact forces on the control 116 that are greater than the impact forces the control 116 is likely to experience when implemented in an actual controller product (e.g., because the housing 102 absorbs at least some of the impact energy), the test results show that the disclosed assembly of components that make up the control 116 perform very well in mitigating damage to the control 116 and to the components thereof (e.g., the switch 122). The prototype controller was also tested using a standard drop test where the prototype controller is repeatedly dropped from a height of 1 m in different orientations. The results of the standard drop test showed that there was no loss in functionality over multiple drops, and little-to-no perceived degradation in the “feel” of the control 116.

FIG. 6 illustrates a front view of the example controller 100 with example controls for operation by fingers of a user of the controller 100. As mentioned above, the housing 102 of the controller 100 may have various surfaces, including the back surface 104, the top surface 106, and the right surface 108 introduced in FIG. 1A. FIG. 6 shows a front surface 602 of the housing 102. As illustrated in FIG. 6, the front surface 602 of the housing 102 may include a plurality of controls configured to receive input of the user. Touch data generated by the controls may be used to detect a presence, location, and/or gesture of a finger of a user operating the controller 100. In some instances, the front surface 602 of the housing 102 may include one or more front-surface controls that are, in some instances, controllable by one or more thumbs of the user operating the controller 100.

The controls 600(1) and 600(2) are shown as exemplary front-surface controls in the form of trackpads. The front-surface controls may further include one or more trackballs, joysticks, buttons, directional pads (D-pads), or the like. For example, in addition to the left control 600(1) (e.g., left trackpad), the front surface 602 may include a left joystick 604, and/or a left D-pad 606 controllable by a left thumb of the user. In some embodiments, the front surface 602 may include additional left buttons controllable by the left thumb. The front surface 602 may, in addition to the right control 600(2) (e.g., right trackpad), also include a right joystick 200 (which was introduced in FIG. 2), and/or one or more right buttons 608 (e.g., X, Y, A, and B buttons) controllable by a right thumb of the user. In some embodiments, the front surface 602 may include additional right buttons controllable by the right thumb. In some examples, the front surface 602 may include other controls, such as tilting button(s), trigger(s), knob(s), wheel(s), paddles, panels, and/or wings, and the plurality of controls may be configured to receive input from any combination of thumbs and/or fingers of the user. It is to be appreciated that any of the front-surface controls shown in FIG. 6 may include the assembly of components described above with respect to the controls 116 to further enhance the drop resistance of the controller 100. Additionally, or alternatively, the additional top-surface controls (e.g., the controls 114 shown in FIG. 1A), back-surface controls (e.g., the controls 110 and 112 shown in FIG. 1A), right-surface controls, left-surface controls, and/or bottom-surface controls may include the assembly of components described above with respect to the controls 116 to further enhance the drop resistance of the controller 100.

The housing 102 may further includes a left handle 612(1) and a right handle 612(2) by which the user may hold the controller 100 via right and left hands of the user, respectively. Holding the left handle 612(1) in the left hand may provide access to the left front-surface controls, and holding the right handle 612(2) in the right hand may provide access to the right front-surface controls.

The handheld controller 100 may allow for different arrangements or functionalities to modify the configuration of the controller to meet the needs of different applications (e.g., game titles), users, and the like. For example, a user may select which controls to use depending on the gaming application currently executing. Thus, the user may configure the handheld controller 100 to be operated with certain controls depending on certain needs and/or preferences. In some instances, the handheld controller 100 may be dynamically configured depending on which user is currently operating the handheld controller. Furthermore, in some instances, the handheld controller 100 or a remote system may determine the configuration of the handheld controller 100 and which controls are currently being operated, or capable of being operated. This information may be provided to a system executing the current application, which in turn, may make modifications based on the configuration of the handheld controller.

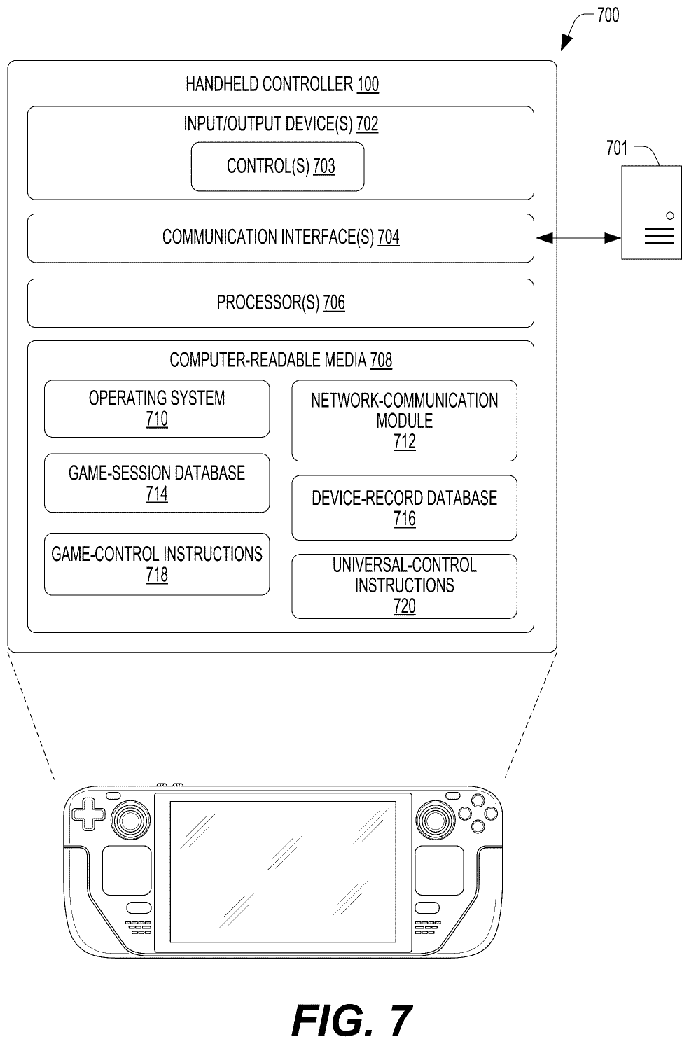

FIG. 7 illustrates example functional components of an example controller system 700. As shown in FIG. 7, the controller system 700 may include one or more remote systems and/or devices 701 communicatively coupled to the handheld controller 100, which itself includes one or more controls 703, such as the controls 110, 112, 114, 116, 200, 600, 604, 606, and/or 608, as described in detail above. As illustrated in FIG. 7, the controller 100 includes one or more input/output (I/O) devices 702, such as the controls 703, and potentially any other type of input or output devices. For example, the I/O devices 702 may include one or more microphones to receive audio input, such as user voice input. In some implementations, one or more cameras or other types of sensors (e.g., inertial measurement unit (IMU)) may function as input devices to receive gestural input, such as motion of the handheld controller 100. In some embodiments, additional input devices may be provided in the form of a keyboard, keypad, mouse, touch screen, joystick, control buttons and the like. The input device(s) may further include control mechanisms, such as basic volume control button(s) for increasing/decreasing volume, as well as power and reset buttons.

The output devices, meanwhile, may include a display 610, a light element (e.g., LED), a vibrator (e.g., haptic actuator(s)) to create haptic sensations, a speaker(s) 614(1), 614(2), headphones, and/or the like. There may also be a simple light element (e.g., LED) to indicate a state such as, for example, when power is on and/or functionalities of the controller (e.g., modes). While a few examples have been provided, the controller 100 may additionally or alternatively include any other type of output device.

In some instances, output by the one or more output devices may be based on input received by one or more of the input devices. For example, selection of a control 703 may result in the output of a haptic response by a vibrator (e.g., haptic actuator) of the control 703 or at any other location within the housing 102 of the controller 100. In some instances, the output may vary based at least in part on a characteristic of a touch input on a touch sensor, such as the touch sensor associated with the control. For example, a touch input at a first location on the touch sensor may result in a first haptic output, while a touch input at a second location on the touch sensor may result in a second haptic output. Furthermore, a particular gesture on the touch sensor may result in a particular haptic output (or other type of output). For instance, a swipe gesture on the control may result in a first type of haptic output, while a tap on the control (detected by the touch sensor) may result in a second type of haptic output, while a hard press of the control may result in a third type of haptic output. Additionally, certain controls or portions of the controls may be illuminated based on received inputs.

In addition, the handheld controller 100 may include one or more communication interfaces 704 to facilitate a wireless connection to a network and/or to one or more remote systems and/or devices 701 (e.g., a host computing device executing an application, a game console, etc.). The communication interfaces 704 may implement one or more of various wireless technologies, such as Wi-Fi, Bluetooth, radio frequency (RF), and so on. It is to be appreciated that the handheld controller 100 may further include physical ports to facilitate a wired connection to a network, a connected peripheral device, or a plug-in network device that communicates with other wireless networks.

In the illustrated implementation, the handheld controller 100 further includes one or more processors 706 and computer-readable media 708. Any reference in the detailed description to a processor(s) may be interpreted as the processor(s) 706, and/or a processor(s) of the remote systems and/or devices 701. In some implementations, the processors(s) 706 may include a central processing unit (CPU), a graphics processing unit (GPU), both CPU and GPU, a microprocessor, a digital signal processor or other processing units or components known in the art. Alternatively, or in addition, the functionally described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, each of the processor(s) 706 may possess its own local memory, which also may store program modules, program data, and/or one or more operating systems.

The computer-readable media 708 may include volatile and nonvolatile memory, removable and non-removable media implemented in any method or technology for storage of information, such as computer-readable instructions, data structures, program modules, or other data. Such memory includes, but is not limited to, random access memory (RAM), read-only memory (ROM), electrically erasable programmable ROM (EEPROM), flash memory or other memory technology, compact disk ROM (CD-ROM), digital versatile disks (DVD) or other optical storage, magnetic cassettes, magnetic tape, magnetic disk storage or other magnetic storage devices, redundant array of independent disks (RAID) storage systems, or any other medium which can be used to store the desired information and which can be accessed by a computing device. The computer-readable media 708 may be implemented as computer-readable storage media (CRSM), which may be any available physical media accessible by the processor(s) 706 to execute instructions stored on the computer-readable media 708. In one basic implementation, CRSM may include RAM and Flash memory. In other implementations, CRSM may include, but is not limited to, ROM, EEPROM, or any other tangible medium which can be used to store the desired information and which can be accessed by the processor(s) 706.

Several modules such as instruction, datastores, and so forth may be stored within the computer-readable media 708 and configured to execute on the processor(s) 706. A few example functional modules are shown as stored in the computer-readable media 708 and executed on the processor(s) 706, although the same functionality may alternatively be implemented in hardware, firmware, or as a system on a chip (SOC).

An operating system module 710 may be configured to manage hardware within and coupled to the handheld controller 100 for the benefit of other modules. In addition, the computer-readable media 708 may store a network-communications module 712 that enables the handheld controller 100 to communicate, via the communication interfaces 704, with one or more other devices 701, such as a personal computing device executing an application (e.g., a game application), a game console, a remote server, or the like. The computer-readable media 708 may further include a game-session database 714 to store data associated with a game (or other application) executing on the controller 100 or on a computing device to which the controller 100 couples. The computer-readable media 708 may also include a device-record database 716 that stores data associated with devices to which the controller 100 couples, such as the personal computing device, game console, remote server or the like. The computer-readable media 708 may further store game-control instructions 718 that configure the controller 100 to function as a gaming controller, and universal-control instructions 720 that configure the handheld controller 100 to function as a controller of other, non-gaming devices.

In some instances, some or all of the components (software) shown in FIG. 7 could be implemented on another computing device(s) 701 that is part of a controller system 700 including the controller 100. In such instances, the processes and/or functions described herein may be implemented by other computing devices 701 and/or the controller 100. By way of example, the controller 100 may couple to a host PC or console in the same environment, a computing device(s)/server and provide the device 701 with data indicating presses, selections, and so forth received at the controller 100. The controller 100, for example, may transmit data indicating touch inputs received at a control 703 (e.g., trackpad) of the controller 100 to the computing device(s) 701, and the computing device(s) 701 may determine characteristics of the data and/or where the touch input is received on the controller 100 (or the control of the controller 100). The computing device 701 may then cause associated actions within a game or application to be performed, and/or the computing device 701 may cause associated output to be provided via output device(s), such as haptic actuator(s) of the control(s) 703. However, while a few scenarios are described, the controller 100 and the computing device(s) 701 may communicatively couple with one another for transmitting and receiving data such that the controller 100, the computing device 701, and/or other devices of the controller system 700 may perform the operations and processes described herein.

Unless otherwise indicated, all numbers expressing quantities, properties, conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. When further clarity is required, the term “about” has the meaning reasonably ascribed to it by a person skilled in the art when used in conjunction with a stated numerical value or range, i.e. denoting somewhat more or somewhat less than the stated value or range, to within a range of ±20% of the stated value; ±19% of the stated value; ±18% of the stated value; ±17% of the stated value; ±16% of the stated value; ±15% of the stated value; ±14% of the stated value; ±13% of the stated value; ±12% of the stated value; ±11% of the stated value; ±10% of the stated value; ±9% of the stated value; ±8% of the stated value; ±7% of the stated value; ±6% of the stated value; ±5% of the stated value; ±4% of the stated value; ±3% of the stated value; ±2% of the stated value; or ±1% of the stated value.

While various examples and embodiments are described individually herein, the examples and embodiments may be combined, rearranged and modified to arrive at other variations within the scope of this disclosure. In addition, although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A controller system comprising:
a processor; and
a controller comprising:
a housing having a top surface; and
a control disposed on the top surface of the housing and controllable by an index finger of a user of the controller, the control comprising:
a cover configured to move in response to a press on the cover by the index finger;
a circuit board disposed behind the cover and within the housing, the circuit board having a cantilever portion, a main body portion, and a cutout defined in the circuit board between the cantilever portion and the main body portion; and
a switch mounted to the circuit board on the cantilever portion and configured to provide, to the processor, data indicative of an actuation of the control based at least in part on the cover moving into engagement with the switch as a result of the press,
wherein the cantilever portion is configured to flex in response to a force applied to the cover satisfying a threshold amount of force.

2. The controller system of claim 1, wherein a stiffness of the cantilever portion is such that the cantilever portion does not flex in response to a force of the press failing to satisfy the threshold amount of force.

3. The controller system of claim 1, wherein the control is a bumper.

4. A controller system comprising:
a processor; and
a controller comprising:
a housing having at least one surface; and
a control disposed on the at least one surface of the housing and controllable by a finger of a user of the controller, the control comprising:
a cover configured to move in response to a press on the cover by the finger;
a circuit board disposed behind the cover and within the housing, the circuit board having a cantilever portion, a main body portion, and a cutout defined in the circuit board between the cantilever portion and the main body portion; and
a switch mounted to the circuit board on the cantilever portion and configured to provide, to the processor, data indicative of an actuation of the control based at least in part on the cover moving into engagement with the switch as a result of the press.

5. The controller system of claim 4, wherein a stiffness of the cantilever portion is such that the cantilever portion does not flex in response to a force of the press failing to satisfy a threshold amount of force.

6. The controller system of claim 4, wherein the control is a bumper.

7. The controller system of claim 4, wherein:
the at least one surface is a top surface;
the housing has a front surface; and
a plane of the circuit board is substantially parallel to the front surface of the housing.

8. The controller system of claim 4, wherein the cantilever portion and the main body portion are coplanar.

9. The controller system of claim 4, wherein the cantilever portion is configured to move from an initial position to a maximum deflected position where the cantilever portion has moved into engagement with the main body portion.

10. The controller system of claim 4, wherein:
the circuit board comprises one or more traces associated with the switch, the one or more traces configured to deliver, to the processor, electrical signals corresponding to the data; and
a width of an individual trace of the one or more traces is at least about 30 mils.

11. The controller system of claim 4, wherein:
the circuit board comprises a plurality of traces associated with the switch, the plurality of traces configured to deliver, to the processor, electrical signals corresponding to the data;
a first subset of the plurality of traces represents one or more primary traces; and
a second subset of the plurality of traces represents one or more backup traces configured to deliver the electrical signals if the one or more primary traces become damaged due to flexion of the cantilever portion.

12. The controller system of claim 4, wherein:
the cutout has a first width along a length of the cutout; and
a terminating end of the cutout has a second width greater than the first width.

13. The controller system of claim 4, wherein the circuit board of the control is configured to be replaced without having to replace a main printed circuit board assembly (PCBA) of the controller.

14. The controller system of claim 4, wherein:
the cover comprises a projection that extends from a back side of the cover towards the switch;
a cap is disposed on the projection; and
the cap is made of a compliant material and is configured to engage the switch as a result of the press.

15. A control of a controller, the control comprising:
a cover configured to move in response to a press on the cover by a finger;
a circuit board configured to be disposed behind the cover and within a housing of the controller, the circuit board having a cantilever portion, a main body portion, and a cutout defined in the circuit board between the cantilever portion and the main body portion; and
a switch mounted to the circuit board on the cantilever portion and configured to provide, to a processor, data indicative of an actuation of the control based at least in part on the cover moving into engagement with the switch as a result of the press.

16. The control of claim 15, wherein a stiffness of the cantilever portion is such that the cantilever portion does not flex in response to a force of the press failing to satisfy a threshold amount of force.

17. The control of claim 15, wherein the control is a bumper.

18. The control of claim 15, wherein the cantilever portion and the main body portion are coplanar.

19. The control of claim 15, wherein the cantilever portion is configured to flex in response to a force applied to the cover satisfying a threshold amount of force.

20. The control of claim 15, wherein:
the cutout has a first width along a length of the cutout; and
a terminating end of the cutout has a second width greater than the first width.
